(19) United States
(12) Patent Application Publication
(10) Pub. No.: US 2014/0138340 A1
(43) Pub. Date: May 22, 2014

(54) Overhead Hoist

(71) Applicant: Robert W. Miller, Huntington Beach, CA (US)

(72) Inventor: Robert W. Miller, Huntington Beach, CA (US)

(21) Appl. No.: 13/680,456

(22) Filed: Nov. 19, 2012

(51) Int. Cl. B66D 1/34; B66C 19/00; B66D 1/36

(52) U.S. Cl. CPC B66D 1/34; B66D 1/36; B66C 19/00
USPC 212/336; 254/338; 254/336

(57) ABSTRACT

The hoist winch system of the present invention uses a cable drum that allows a web cable to be attached to the wind drum at a mid-point along the length of cable. The single cable has web loops at the two opposite ends. The wind drum winds both sections of the web cable at the same time, but the cable ends are routed by separate guide pulleys extended horizontally to the lift pulleys that direct each line segment down to the object to be lifted at separated points

The hoist winch system of the present invention uses a cable drum that avows a web cable to be attached to the wind drum at a mid-point along the length of cable. The single cable has web loops at the two opposite ends. The wind drum winds both sections of the web cable at the same time, but the cable ends are routed by separate guide pulleys extended horizontally to the lift pulleys that direct each line segment down to the object to be lifted at separated points.

### BACKGROUND OF THE INVENTION

1. Field of the Invention

The present invention relates to improvements in workplace electric hoist designs to provide a single hoist having dual lift lines to provide better stability for a lifted object. The inventive hoist readily attaches to ceiling beams in garages and workshops

2. Background Art

In standard practice, workplace hoists use an electric winch motor to wind a cable. The cable is typically either a wire rope, or a segmented chain. The hoist operation is controlled by the operator with use of a hand held remote switch. These hoists can work satisfactorily for small regular shaped objects with a lift point at the exact center of gravity (CG) of the object. Objects lifted by these single line lifts at the CG point still are subject to a swinging or rotational movement that must be hand guided for safety. Large, cumbersome and odd-shaped objects must be carefully lifted and hand guided when lifted by a single line.

### SUMMARY OF THE INVENTION

Accordingly, it is the general object of the present invention to provide an electric hoist system that provides a double line lift system.

The hoist winch system of the present invention uses a cable drum that allows a web cable to be attached to the wind drum at a mid-point along the length of cable. The single cable has web loops at the two opposite ends. The wind drum winds both sections of the web cable at the same time, but the cable ends are routed by separate guide pulleys extended horizontally to the lift pulleys that direct each line segment down to the object to be lifted at separated points.

Typically, the pulleys are spaced equidistant from the winch motor, but when desired, the pulleys can be offset as required for a special lifting task. In such case, it would only require a quick adjustment of the attach point of the web cable on the cable drum.

The web cable itself typically is a thin gage (.045″) by 3.0 inch wide, tight woven nylon webbing such as is available from Lowy Enterprises, Inc. Breaking strength is at least 3200 lbs. This 3.0 inch wide cable provides good lateral stability compared to a single line hook.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a perspective illustration of prior art work-place hoist;

FIGS. 2A is a perspective illustration showing the inventive dual lift line hoist basic configuration

FIG. 2B is a perspective illustration of how the dual line lift hoist could be configured to lift an odd shaped object;

FIG. 2C is a perspective illustration of how the dual line lift system can be attached to ceiling beams;

FIG. 3 is a perspective view depicting how the web cable attaches to the winch drum in a preferred embodiment hereof;

FIG. 4 is a perspective view of a hat-section ceiling mount which typically would be tied into two parallel ceiling beams with lag screws. Also depicted is the 90 degree adapter plate, which bolts to the winch motor and enables the dual line hoist to be aligned either parallel or perpendicular to ceiling beams;

FIGS. 5A and 5B are respective layout views of the inventive hoist system installed at a ceiling as viewed from ceiling level and below with the winch housing oriented to have the web cable run parallel to the ceiling beams.

FIG. 6 comprising FIGS. 6A and 6B, depicts how the inventive hoist system can be adjusted after installation to accommodate different lifted objects and how the center of lift point can be moved along the axis of the pulley channels;

FIG. 7A depicts how the hoist system can be used in combination with a trolley to provide a lift system that can lift with dual cables, and after lifting can be moved horizontally to a new position along a trolley track; and

FIG. 7B depicts how this hoist system can be used in combination with an inclined track trolley that incorporates the power of the winch to not only lift the intended object, but to then move the loaded trolley back up to the upper location of the track.

### DETAILED DESCRIPTION OF THE PREFERRED EMBODIMENTS

Referring initially to FIG. 1, a perspective illustration of typical prior art workplace hoist 5 is shown therein. These prior art single lift point hoists are designed to be attached to eyebolts in overhead beams. While these prior art hoists are useful for many small regular shaped items with a known CG point, they are not ideal for handling large, cumbersome objects.

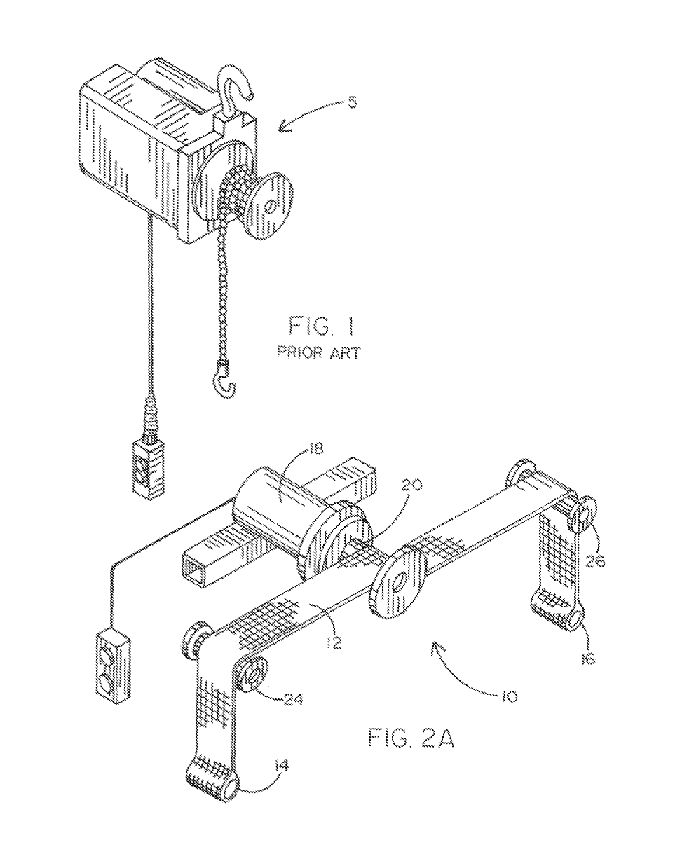

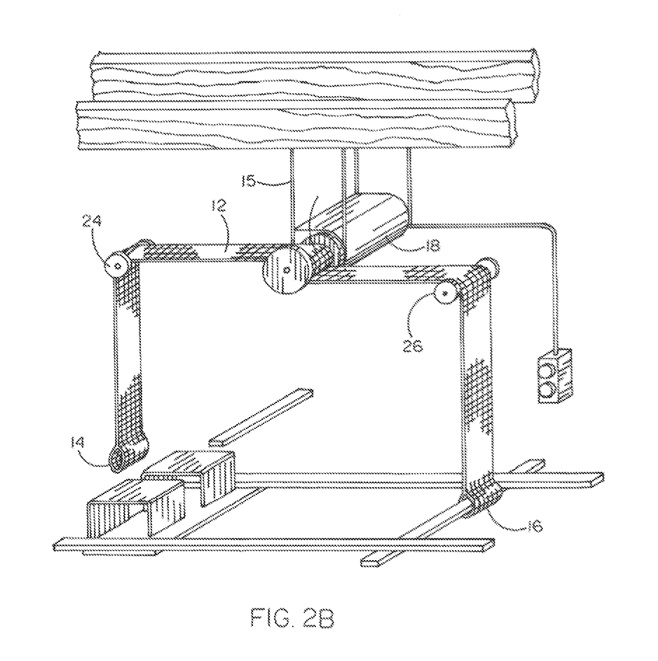

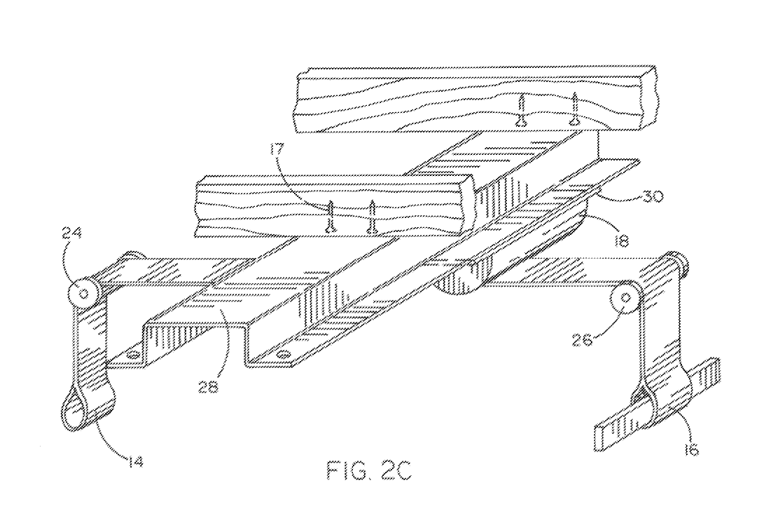

For many small shops and independent contractors, a ceiling hoist that would handle odd shaped items such as tool boxes, generators, truck racks, etc. would be very useful. FIG. 2A is a perspective illustration of the inventive lift system 10 that uses a three inch wide web cable 12 that lifts the intended object at two separate points 14 and 16 simultaneously.

The inventive hoist system 10 is powered by an electric winch 18 that has its drum 20 adapted to use a single web cable.

FIG. 2B illustrates how the hoist system 10 of FIG. 2A may be hung from beams using vertical members 15. FIG. 2C illustrates how the system 10 may be mounted directly to the beams by means of a hat section 28 and an adapter plate 30 and lag screws 17.

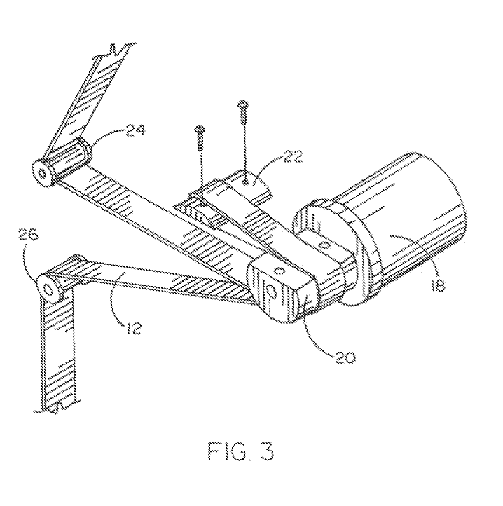

FIG. 3 depicts the cross-section shape of winch drum 20 with the conformable web cable clamp 22. This web cable clamp 22 of the drum 20 allows for quick adjustment in location of the clamping point which adjusts line lengths from ceiling to web cable end loops, Pulleys 24 and 26 are used to redirect the direction of the web cable from horizontal to the vertical.

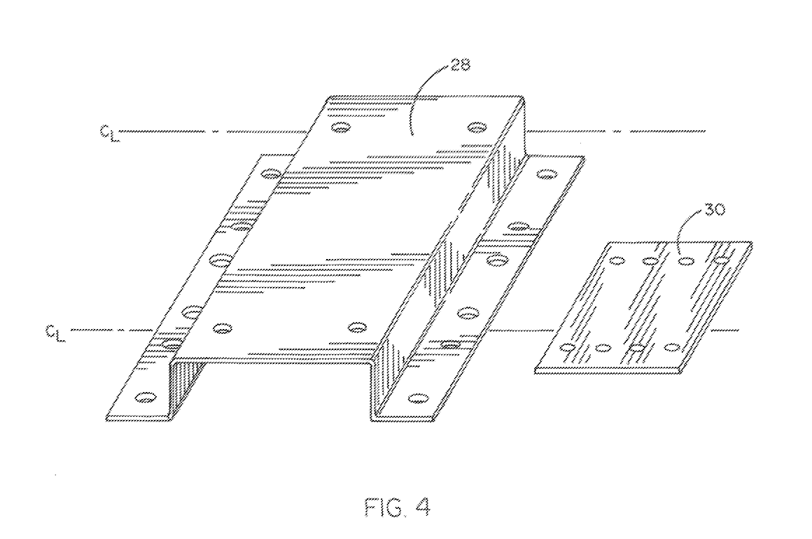

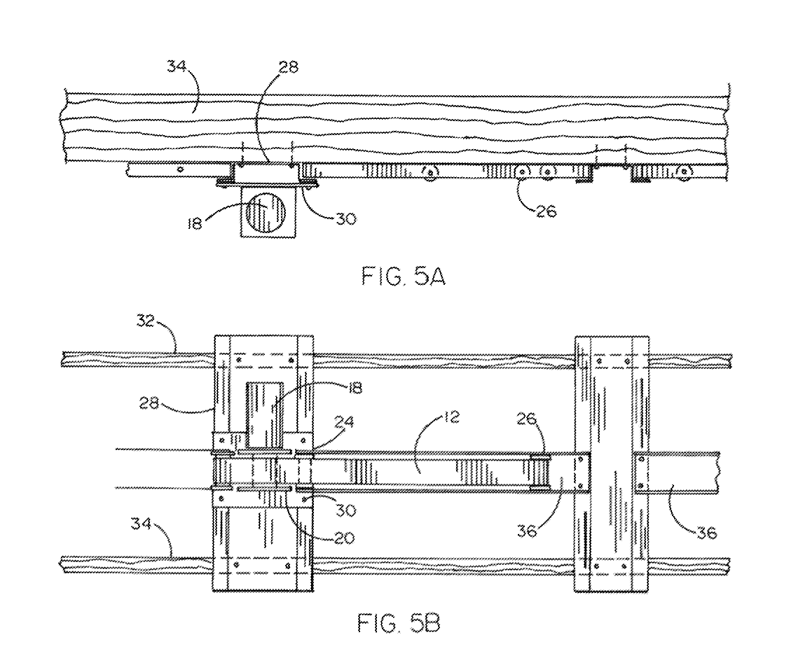

The inventive hoist system may provide a hat-section mount beam 28 for attachment at four points with lag screws to parallel ceiling beams 32 and 34. See FIGS. 2C and 4. The hat-section beam employs an adapter plate 30 that allows the hoist system to be set up to have the vertical lifting pulleys 24 and 26 aligned in orientation either parallel or perpendicular to the ceiling beams. FIGS. 5A and 5B illustrate one such perpendicular arrangement with a number of alternative pulley locations along the length of the beams 32 and 34.

The hoist system assembly of FIGS. 5A and 5B contains a set of pulley channel sections 36 that locate the lift pulleys in proper alignment to the winch drum. The pulley channels allow for horizontal adjustment of the lift pulley locations. Multiple pulley channels can be assembled together to accommodate lifting very long items.

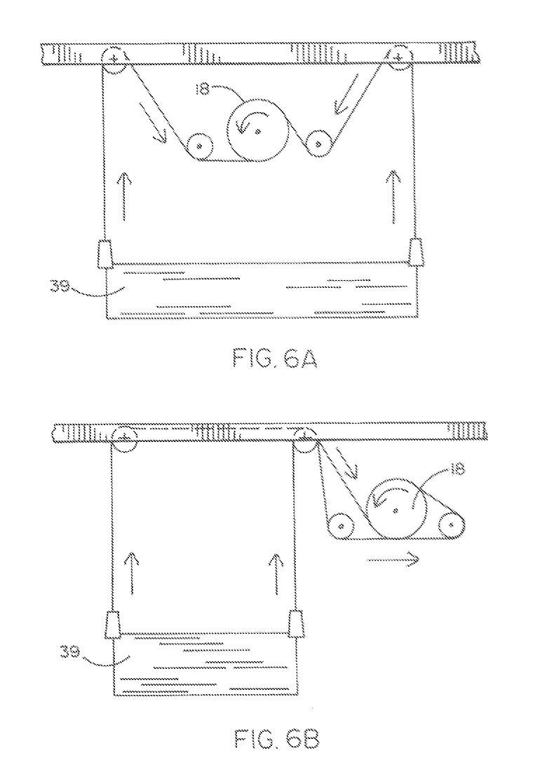

FIG. 6 comprising 6A and 6B are illustrations depicting how the hoist pulley system can be set up to accommodate different length items 39 and different center-of-lift locations along the pulley axis. Since the web cable material is low friction and both sections of the cable are moving at a near identical speed, the adjacent cables can share a single pulley. While this inventive hoist system is mounted in a fixed position relative to the ceiling beams, the capability to adjust location of the lift pulleys adds to the versatility of this system.

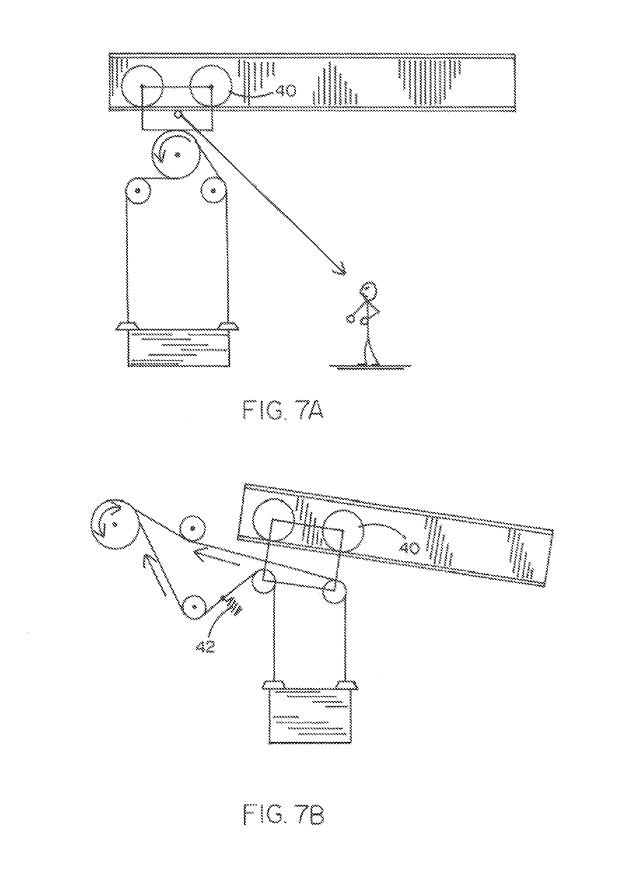

FIG. 7A is a depiction of how the hoist system can be used in combination with a tracked trolley 40 that carries the entire hoist assembly including the dual lift pulleys. The trolley mounted hoist is latched in position at each end of the track for loading/unloading, then manually towed to the opposite position.

In FIG. 7B, a further option is shown to have the trolley 40 carry the only dual lifting pulleys. With the track inclined only slightly (5 degrees), the trolley, when released, would roll down to lower position as the hoist winch is unspooled. The trolley latches into that position and further unspooling lowers the dual lift cables. The web cable for the dual lift line would go through a self-locking web clamp that when engaged, only allows the web cable to advance in toward the winch unit. A self-activating web clamp design is disclosed in U.S. patent application Ser. No. 12/930,159. This type of set up would require a larger diameter winch drum to accommodate the length of the trolley. The lift object is raised to a required height and held by the web clamps. The trolley position lock is released, and then further wind up of the web cable, tows the pulley trolley and the carried object up the track to a final lock position. Since the web cables are now locked in position, a web-tensioner 42 would be used on the inner web cable between the winch drum and the trolley to maintain a minimum tension.

The typical winches currently available for this type of application are limited in drum diameter to about 4 inch OD. That 4 inch diameter allows the described dual-line hoist to wind approximately 20 ft. of the described 0.045″ cable resulting in just under 10 ft. of available lift height.

It can be seen that another embodiment of this winch hoist system would have the ceiling mount adapter connected to a rotating ring which would allow the basic hoist system to rotate 360 degrees. The separation distance of the dual lift lines would be limited to approximately the diameter of the bearings of the rotating ring. Such a dual line system could be useful in certain assembly operations.

It will now be understood that the present invention comprises unique features in a hoist system that provides for greater safety and efficiency in shop hoist operations. While alternative embodiments have been discussed herein, it will be clear that the scope hereof is to be determined only by the appended claim and their legal equivalents.

What is claimed is:

1. A hoist system for lifting an object at at least two spaced-apart locations using a single winch; the system comprising:
a unitary motorized winch having a winding drum;
at least two cable sections affixed to said winding drum to be wound simultaneously in the same direction;
each of said cable sections terminating in a respective lifting attachment for connection to a body to be lifted by said hoist system; and
at least two pulleys at separated positions relative to said winding drum and elevated above said body to be lifted; said cable sections being routed respectively over said pulleys to provide said lifting attachments at said space-apart locations for lifting said body.

2. The hoist system recited in claim 1 wherein said cable sections are respective portions of a single cable.

3. The hoist system recited in claim 2 wherein said cable sections are web-shaped.

4. The hoist system recited in claim 3 wherein said lifting attachments are closed loops.

5. The hoist system recited in claim 1 wherein said winch is mounted to at least one ceiling beam.

6. The hoist system recited in claim 5 wherein said winch is interconnected to said at least one ceiling beam by a bracket configured for either parallel or perpendicular mounting of said winch relative to said beam.

7. The hoist system recited in claim 1 wherein said at least two pulleys are mounted at alternative positions for selecting different spaced-apart locations.

8. The hoist system recited in claim 1 wherein said winch is attached to a trolley mounted on a track for altering the location of said hoist system.

9. The hoist system recited in claim 8 wherein said track is tilted to be non-horizontal.

10. The hoist system recited in claim 1 wherein said cable sections share at least one of said pulleys.
